(19) United States
(12) Patent Application Publication
(10) Pub. No.: US 2015/0377088 A1
(43) Pub. Date: Dec. 31, 2015

(54) CAMSHAFT BEARING STRUCTURE

(71) Applicant: TOYOTA JIDOSHA KABUSHIKI KAISHA, Toyota-shi (JP)

(72) Inventors: Masahiro FUJIWARA, Okazaki-shi (JP); Yuta NISHIMURA, Toyota-shi (JP)

(73) Assignee: TOYOTA JIDOSHA KABUSHIKI KAISHA, Toyota-shi (JP)

(21) Appl. No.: 14/747,330

(22) Filed: Jun. 23, 2015

(30) Foreign Application Priority Data
Jun. 25, 2014 (JP) 2014-130118

(51) Int. Cl. F01L 1/46; F01L 1/047; F02F 1/24

(52) U.S. Cl. CPC F01L 1/46; F02F 1/24; F01L 1/047

(57) ABSTRACT

A bearing structure for a camshaft includes a bearing part that includes a cylinder head, a cam cap, and a positioning member. The cam cap is assembled to an upper part of the cylinder head. The cylinder head and the cam cap define a journal hole. The cylinder head and the cam cap rotatably support the camshaft in the journal hole. The positioning member determines the position where the cylinder head and the cam cap are assembled to each other. The positioning member is press-fitted into the cylinder head and the cam cap. In the bearing part for the camshaft, the positioning member is provided only in an inner part, which is a part of the bearing part between an axis of the camshaft and a center of an upper part of the cylinder head.

### INCORPORATION BY REFERENCE

The disclosure of Japanese Patent Application No. 2014-130118 filed on Jun. 25, 2014 including the specification, drawings and abstract is incorporated herein by reference in its entirety.

### BACKGROUND OF THE INVENTION

1. Field of the Invention

The present invention relates to a camshaft bearing structure that rotatably supports a camshaft.

2. Description of Related Art

Japanese Patent Application Publication No, 2011-241700 (JP 2011-241700 A) discloses one example of a bearing structure for an intake camshaft or exhaust camshaft. As shown in FIG. 4, this bearing structure has a bearing part 102 that rotatably supports a camshaft 101 that extends through a journal hole 100. The journal hole 100 is defined by an upper part of a cylinder head 103 and a cam cap 104 that is assembled to the upper part of the cylinder head 103. The bearing part 102 includes pins 105 that are press-fitted into both the upper part of the cylinder head 103 and the cam cap 104. When the cylinder head 103 and the cam cap 104 are assembled to each other, the cam cap 104 is assembled at a predetermined position on the cylinder head 103 by press-fitting the pins 105 into the cylinder head 103 and the cam cap 104.

### SUMMARY OF THE INVENTION

When the cylinder head 103 is deformed by heat from exhaust gas, the cylinder head 103 is deformed such that an upper part thereof gradually rises toward a lateral side 106 of the cylinder head 103 as shown in FIG. 5. Because the cam cap 104 is fixed to the cylinder head 103 by the pins 105, the semi-circular arch-shaped portion of the cam cap 104 that surrounds the journal hole 100 is distorted toward a center 107 of the cylinder head 103 (rightward as viewed in FIG. 5) as indicated by solid lines in FIG. 5 when the cylinder head 103 is deformed such that an upper part thereof is raised upward. When the cam cap 104 is deformed in this manner, the shape of the journal hole 100 is changed and the clearance between the inner wall of the journal hole 100 and the camshaft 101 is partially reduced. Then, the camshaft 101 may be seized.

In particular, in the vicinity of the exhaust camshaft, the cylinder head tends to become very hot because of heat from the exhaust gas and therefore undergoes a large degree of thermal deformation. Thus, seizure as described above is likely to occur. The present invention provides a camshaft bearing structure in which deformation of the cylinder head does not lead to significant deformation of the journal hole.

A bearing structure for a camshaft according to one aspect of the present invention includes a bearing part that includes a cylinder head, a cam cap, and a positioning member. The cam cap is assembled to an upper part of the cylinder head.

The cylinder head and the cam cap define a journal hole. The cylinder head and the cam cap are configured to rotatably support the camshaft in the journal hole. The positioning member determines the position where the cylinder head and the cam cap are assembled to each other. The positioning member is press-fitted into the cylinder head and the cam cap. In the bearing part for the camshaft, the positioning member is provided only in an inner part, which is a part of the bearing part between an axis of the camshaft and a center of an upper part of the cylinder head.

Regarding the bearing structure, in the bearing part for the camshaft, the positioning member may not be provided in an outer part, which may be a part of the bearing part on the opposite side of the inner part with respect to the axis of the camshaft.

Regarding the bearing structure, when the upper part of the cylinder head is deformed, the cylinder head may be displaced toward a lateral side of the cylinder head relative to the cam cap in the outer part of the bearing part.

The bearing structure may further include a bolt. The cam cap may have a bolt hole, the cam cap and the cylinder head may be secured to each other by the bolt, and a clearance may be provided between the bolt and a wall surface of the bolt hole.

Regarding the bearing structure, the camshaft may be an exhaust camshaft.

The bearing part for an exhaust camshaft tends to become very hot because of heat from exhaust gas and therefore tends to undergo a large degree of thermal deformation. According to the above configuration, the cam cap is not restrained by a positioning member in the outer part of the bearing part for the exhaust camshaft. Thus, when the cylinder head is deformed such that an upper part thereof gradually rises toward a lateral side of the cylinder head due to heat from exhaust gas, the cylinder head is displaced relative to the cam cap in the outer part. Thus, compared to the case where the cam cap is restrained by positioning members, the semi-circular arch-shaped portion of the cam cap that surrounds the journal hole undergoes a smaller degree of deformation and the resulting deformation of the journal hole will be smaller. As a result, deformation of the cylinder head does not lead to significant deformation of the journal hole.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a cross-sectional view of one embodiment of a camshaft bearing structure;

FIG. 2 is a cross-sectional view that illustrates, in an enlarged manner, a bearing part for an exhaust camshaft according to the embodiment;

FIG. 3 is a cross-sectional view that schematically illustrates a manner of deformation of the bearing part for an exhaust camshaft according to the embodiment;

FIG. 4 is a cross-sectional view that illustrates a camshaft bearing structure according to a related art; and

FIG. 5 is a cross-sectional view that schematically illustrates a manner of deformation of a bearing part in a camshaft bearing structure according to the related art.

### DETAILED DESCRIPTION OF EMBODIMENTS

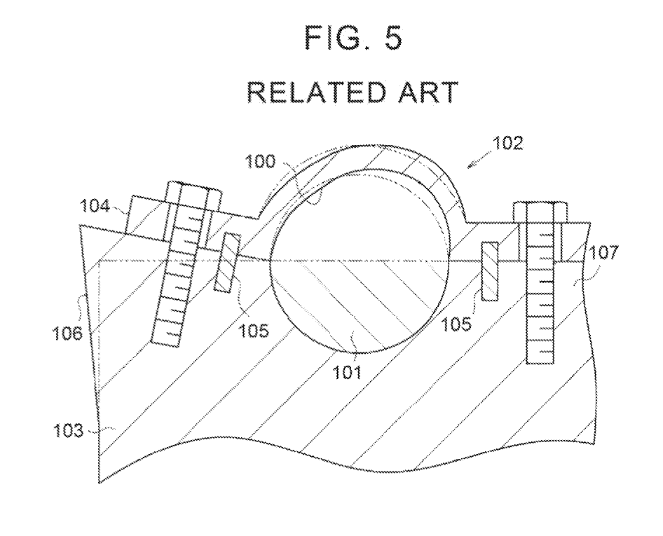

One embodiment of a camshaft bearing structure is hereinafter described with reference to FIG. 1 to FIG. 5. As shown in FIG. 1, the camshaft bearing structure has bearing parts 4. Each bearing part 4 rotatably supports an exhaust camshaft 2 or intake camshaft 3 that extends through a journal hole 1. Semicircular recesses 7 are provided side by side in an upper surface of a cylinder head 5. A cam cap 6 has semicircular recesses 8 that are defined by semi-circular arch-shaped portions opposed to the recesses 7 and symmetrical in shape to the recesses 7. The cam cap 6 is assembled to an upper surface of the cylinder head 5, so that circular journal holes 1 are formed by the recesses 7 and the recesses 8. In this way, the journal holes 1 of the bearing parts 4 are formed by an upper part of the cylinder head 5 and the cam cap 6, which is assembled to the upper part of the cylinder head 5, The cylinder head 5 is assembled to a cylinder block 10 that is located under the cylinder head 5 via head bolts 9 that extends through the cylinder head 5 from the upper surface thereof.

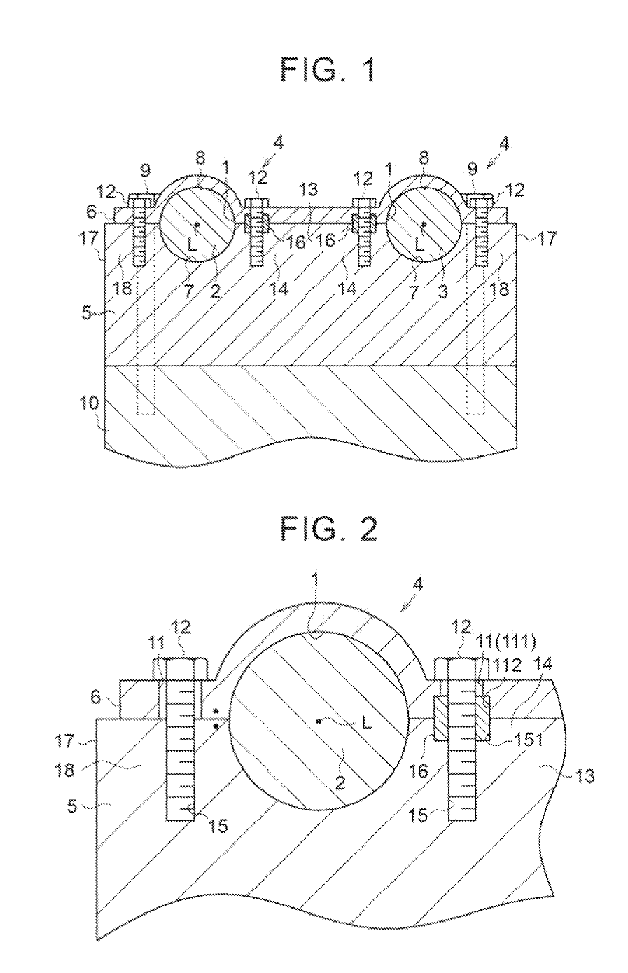

The configuration of the bearing part 4 for the exhaust camshaft 2 is next described with reference to FIG. 2. The bearing part 4 for the intake camshaft 3 is generally the same in configuration as the bearing part 4 for the exhaust camshaft 2. Thus, description of the configuration of the bearing part 4 for the intake camshaft 3 is omitted in the following.

As shown in FIG. 2, the cam cap 6 has a pair of bolt holes 11 on opposite sides of the journal hole 1. The cam cap 6 and the cylinder head 5 are secured to each other via bolts 12 that are inserted into the bolt holes 11. A clearance is provided between each bolt 12 and the wall surface of its corresponding bolt hole 11.

In the part of the bearing part 4 between the axis L of the camshaft 2 and a center 13 of an upper part of the cylinder head 5 (which is hereinafter referred to as “inner part 14”), the bolt hole 11 that is formed through the cam cap 6 (which is hereinafter referred to also as “bolt hole 111”) has, at its lower end, a large diameter portion 112 that has a diameter larger than that of the upper end thereof.

Screw holes 15 into which bolts are threaded are provided at locations opposed to the bolt holes 11 in an upper part of the cylinder head 5. A large diameter portion 151 with the same shape as the large diameter portion 112 is formed at a location opposed to the large diameter portions 112 by increasing the diameter of an upper part of the corresponding screw hole 15. A pin ring 16 as a positioning member that determines the position where the cylinder head 5 and the cam cap 6 are assembled to each other is press-fitted into the large diameter portion 112 and the large diameter portion 151. The pin ring 16 has a cylindrical shape, and has an inside diameter that is generally the same as the outside diameter of the bolts 12. The bolt 12 that is inserted through the bolt hole 111 extends through the pin ring 16 and threaded into the corresponding screw hole 15 of the cylinder head 5.

In the bearing part 4, the pin ring 16 is not provided in the part on the opposite side of the inner part 14 with respect to the axis L of the camshaft 2, in other words, the part closer to the lateral side 17 of the cylinder head 5 (which is hereinafter referred to as “outer part 18”).

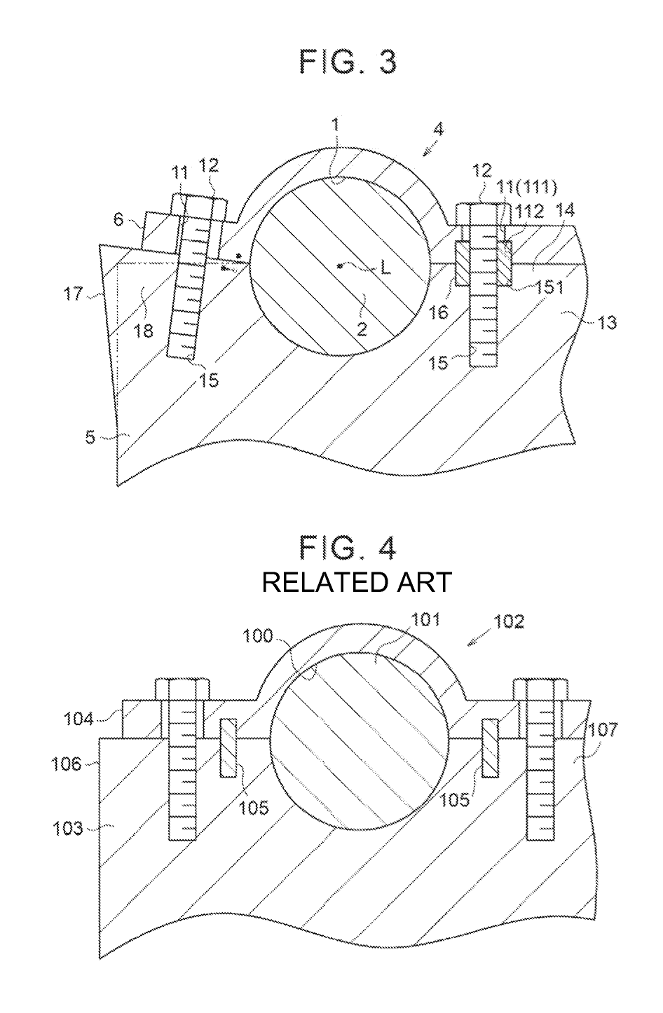

The function and effect of this embodiment are next described with reference to FIG. 3. As shown in FIG. 3, the cylinder head 5 is deformed such that an upper part thereof gradually rises toward the lateral side 17 due to heat from exhaust gas. In addition, when the cylinder head 5 is assembled to the cylinder block 10 via the head bolts 9, the upper surface of the cylinder head 5 is pressed by the heads of the head bolts 9 and distorted into a concave shape. Thus, the force that is applied to fasten the head bolts 9 causes deformation as described above in an upper part of the cylinder head 5. When an upper part of the cylinder head 5 is deformed in this manner, the outer part 18 of the bearing part 4 is also deformed.

In this embodiment, the pin ring 16 is not provided in the outer part 18, which undergoes a larger degree of deformation, and the pin ring 16 is provided only in the inner part 14 in the bearing part 4. In other words, the portion of the cam cap 6 in the outer part 18 is not restrained by the pin ring 16. Thus, when the cylinder head 5 is deformed such that an upper part thereof gradually rises toward the lateral side 17 due to heat from exhaust gas or assembling using the head bolts 9, the cylinder head 5 is displaced toward the lateral side 17 relative to the cam cap 6 in the outer part 18 of the bearing part 4 as indicated by black circles that are shown in FIG. 2 and FIG. 3. Thus, compared to the case where the cam cap 6 is restrained by pin rings 16, the semi-circular arch-shaped portion of the cam cap 6 that surrounds the journal hole 1 undergoes a smaller degree of deformation and the resulting deformation of the journal hole 1 will be smaller. Thus, even when the cylinder head 5 is deformed, the resulting deformation of the journal hole 1 will not be so large as to cause seizure of the camshaft 2.

The above embodiment may be implemented with any of the following modifications. While the journal hole 1 for the exhaust camshaft 2 and the journal hole 1 for the intake camshaft 3 are formed by one cam cap 6, each journal hole 1 may be formed by a dedicated cam cap.

The cylinder head 5 may be constituted of a cylinder head main body and a cam housing that is secured to an upper part of the cylinder head main body, and the cam cap 6 may be assembled to an upper part of the cam housing.

While an arrangement in which the pin ring 16 is provided only in the inner part 14 of the bearing part 4 is applied to both the bearing part 4 for the exhaust camshaft 2 and the bearing part 4 for the intake camshaft 3, this arrangement may be applied only to the bearing part 4 for the exhaust camshaft 2.

While description is made of an example in which the pin rings 16 are used as the positioning members in the above embodiment, the pins 105, which are employed in the bearing structure of the related art, for example, may be employed as the positioning members.

What is claimed is:

1. A bearing structure for a camshaft, the bearing structure comprising:
a bearing part that includes a cylinder head, a cam cap, and a positioning member, the cam cap being assembled to an upper part of the cylinder head, the cylinder head and the cam cap defining a journal hole, the cylinder head and the cam cap configured to rotatably support the camshaft in the journal hole, the positioning member determining the position where the cylinder head and the cam cap are assembled to each other, the positioning member being press-fitted into the cylinder head and the cam cap,
wherein, in the bearing part for the camshaft, the positioning member is provided only in an inner part, the inner part being a part of the bearing part between an axis of the camshaft and a center of the upper part of the cylinder head.

2. The bearing structure according to claim 1, wherein,
in the bearing part for the camshaft, the positioning member is not provided in an outer part, the outer part being a part of the bearing part on the opposite side of the inner part with respect to the axis of the camshaft.

3. The bearing structure according to claim 2, wherein,
when the upper part of the cylinder head is deformed, the cylinder head is displaced toward a lateral side of the cylinder head relative to the cam cap in the outer part of the bearing part.

4. The bearing structure according to claim 1, further comprising:
a bolt,
wherein the cam cap has a bolt hole, the cam cap and the cylinder head are secured to each other by the bolt, and a clearance is provided between the bolt and a wall surface of the bolt hole.

5. The bearing structure according to claim 1, wherein
the camshaft is an exhaust camshaft.
